(19) United States
(12) Patent Application Publication
(10) Pub. No.: US 2026/0237391 A1
(43) Pub. Date: Aug. 13, 2026

(54) SPEECH RECOGNITION METHOD AND SPEECH RECOGNITION SYSTEM

(71) Applicant: REALTEK SEMICONDUCTOR CORPORATION, HSINCHU (TW)

(72) Inventor: KAI-HSIANG CHOU, HSINCHU (TW)

(21) Appl. No.: 19/535,500

(22) Filed: Feb. 10, 2026

(30) Foreign Application Priority Data
Feb. 11, 2025 (TW) 114105092

(51) Int. Cl. G10L 15/32; G10L 15/08; G10L 15/22

(52) U.S. Cl. CPC G10L 15/32; G10L 15/08; G10L 15/22; G10L 2015/088; G10L 2015/223; G10L 2015/227

(57) ABSTRACT

A speech recognition method executed by a processor reading at least command stored in a memory is disclosed herein. The speech recognition method includes following steps: performing a speech recognition on a speech input by at least two algorithms to generate at least two speech recognition results; if the at least two speech recognition results conform to at least two corresponding speech recognition conditions, generating at least two pass signals; and generating at least one speech recognition command according to the at least two pass signals.

### BACKGROUND OF THE INVENTION

### 1. Field of the Invention

The present disclosure relates to a speech recognition method and a speech recognition system, especially to a speech recognition method and a speech recognition system configured to accurately recognize a speech recognition command through at least two algorithms.

### 2. Description of Related Art

The speech input has been widely applied to various electronic devices. For example, an electronic device may be awakened through a wake word to perform the speech input. However, the manner of awakening the electronic device through the wake word often results in false awakening. In other words, when a user does not need to awaken the electronic device, the electronic device mistakenly determines other vocabularies as the wake word and is falsely awakened. If the electronic device thereby launches an application to dim a screen, reduce an output volume, or even output a greeting, it will cause inconvenience to the user. For example, when driving, if a navigation screen is dimmed, it will affect driving safety, or during a meeting, if the electronic device outputs a greeting, it will affect the meeting progress and make attendees feel disrespected.

### SUMMARY OF THE INVENTION

In some aspects, an object of the present disclosure is to, but not limited to, provide a speech recognition method and a speech recognition system that make an improvement to the prior art.

In some embodiments, the present disclosure provides a speech recognition method, executed by a processor reading at least one command stored in a memory. The speech recognition method includes: performing a speech recognition on a speech input by at least two algorithms to generate at least two speech recognition results; if the at least two speech recognition results conform to at least two corresponding speech recognition conditions, generating at least two pass signals; and generating at least one speech recognition command according to the at least two pass signals.

In some embodiments, a speech recognition system includes a memory and a processor. The memory is configured to store at least one command. The processor is configured to read the at least one command in the memory to execute: performing a speech recognition on a speech input by at least two algorithms to generate at least two speech recognition results; if the at least two speech recognition results conform to at least two corresponding speech recognition conditions, generating at least two pass signals; and generating at least one speech recognition command according to the at least two pass signals.

Technical features of some embodiments of the present disclosure make an improvement to the prior art. The speech recognition method and the speech recognition system of the present disclosure can perform a speech recognition on a speech input through at least two algorithms to further accurately recognize a corresponding speech recognition command. As a result, the present disclosure can avoid a false awakening caused by a speech recognition error, thereby preventing inconvenience caused by a false awakening of an electronic device. For example, the present disclosure can avoid affecting driving safety due to a navigation screen being dimmed while driving, and can also avoid affecting a meeting progress due to an electronic device outputting a greeting during a meeting.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a speech recognition system of the present disclosure.

FIG. 2 shows an embodiment of a flow diagram of a speech recognition method the present disclosure.

FIG. 3 shows an embodiment of a flow diagram of a speech recognition method of the present disclosure.

FIG. 4 shows an embodiment of a flow diagram of a speech recognition method of the present disclosure.

### DETAILED DESCRIPTION OF THE PREFERRED EMBODIMENTS

In order to avoid a false awakening caused by a speech recognition error, thereby preventing inconvenience caused by a false awakening of an electronic device, the present disclosure provides a speech recognition method and a speech recognition system, which will be described in detail below.

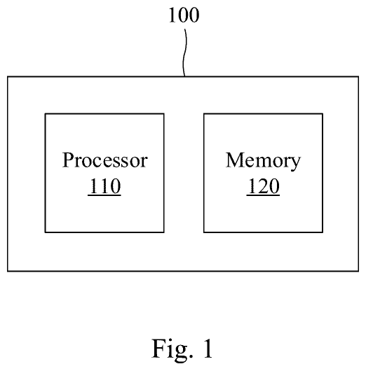

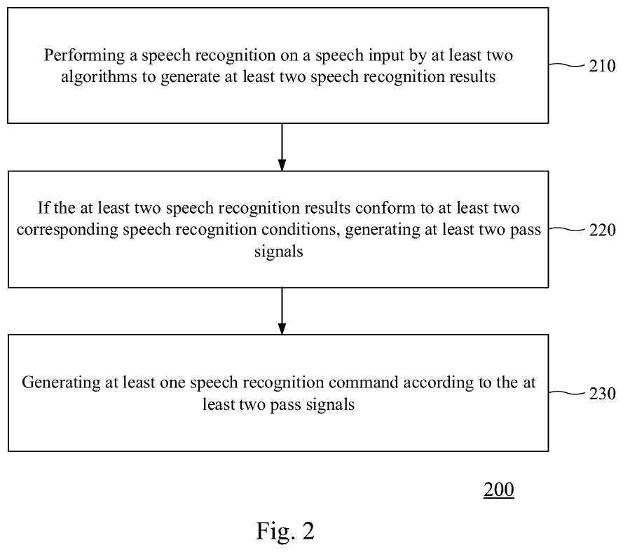

FIG. 1 shows an embodiment of a speech recognition system 100 of the present disclosure. As shown, the speech recognition system 100 includes a processor 110 and a memory 120. The memory 120 is configured to store at least one command. The processor 110 is configured to read the at least one command to perform a speech recognition process. To facilitate understanding of the operation of the speech recognition system 100, please also refer to FIG. 2. FIG. 2 shows an embodiment of a flow diagram of a speech recognition method 200 of the present disclosure.

Referring to step 210 in FIG. 2, performing a speech recognition on a speech input by at least two algorithms to generate at least two speech recognition results. For example, referring to FIG. 1, the speech recognition system 100 of the present disclosure may adopt two algorithms to perform the speech recognition on a speech input of a user, and generate two corresponding speech recognition results. It should be noted that the two algorithms adopted in the present disclosure may be different algorithms. However, the present disclosure is not limited thereto, and the present disclosure may also adopt the same algorithm, depending on actual requirements.

Referring to step 220 in FIG. 2, if the at least two speech recognition results conform to at least two corresponding speech recognition conditions, generating at least two pass signals. For example, referring to FIG. 1, if a first speech recognition result of the two speech recognition results conforms to a first corresponding speech recognition condition, and a second speech recognition result of the two speech recognition results also conforms to a second corresponding speech recognition condition, the speech recognition system 100 of the present disclosure may generate two pass signals.

Referring to step 230 in FIG. 2, generating at least one speech recognition command according to the at least two pass signals. For example, referring to FIG. 1, the speech recognition system 100 of the present disclosure may generate a speech recognition command according to the two pass signals. Accordingly, the speech recognition system 100 and the speech recognition method 200 of the present disclosure can perform the speech recognition on the speech input through at least two algorithms to further accurately recognize a corresponding speech recognition command. As a result, the present disclosure can avoid a false awakening caused by a speech recognition error, thereby preventing inconvenience caused by a false awakening of an electronic device. For example, the present disclosure can avoid affecting driving safety due to a navigation screen being dimmed while driving, and can also avoid affecting a meeting progress due to an electronic device outputting a greeting during a meeting.

In some embodiments, referring to step 230 in FIG. 2, if at least one speech recognition command includes a stop word, stopping executing the speech recognition system 100 and/or the speech recognition method 200. For example, if a user finds that the speech input is incorrect, a false awakening occurs, or a false triggering occurs, and the user wants to stop, the user may further output a stop word. When the speech recognition system 100 and/or the speech recognition method 200 of the present disclosure recognizes the stop word, the speech recognition system 100 and/or the speech recognition method 200 can immediately stop being executed. Specifically, assuming that the speech input is incorrect, a false awakening occurs, or a false triggering occurs, the user may output a phrase “assistant down” so that an assistant user interface (assistant UI) immediately exits without waiting for a system time out. In some embodiments, the stop word may be “assistant down”, “back off”, “Siri off”, “BMW away”, and so on. However, the present disclosure is not limited thereto, and the present disclosure may also adopt other suitable stop words, depending on actual requirements.

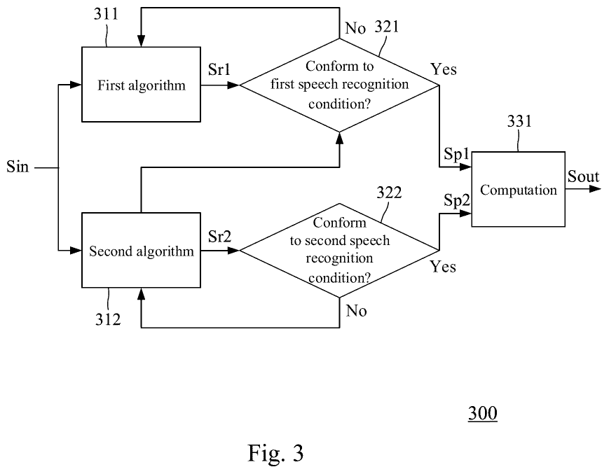

FIG. 3 shows an embodiment of a flow diagram of a speech recognition method 300 of the present disclosure. Referring to step 311 in FIG. 3, the speech recognition system 100 of the present disclosure may adopt a first algorithm to perform the speech recognition on a speech input Sin to generate a first speech recognition result Sr1. Referring to step 312 in FIG. 3, the speech recognition system 100 of the present disclosure may further adopt a second algorithm to perform the speech recognition on the speech input Sin to generate a second speech recognition result Sr2. For example, the speech recognition system 100 of the present disclosure may perform the speech recognition on the speech input by a speech recognition unit through the first algorithm and the second algorithm to generate a first speech feature value Sr1 and a second speech feature value Sr2.

Referring to step 321 in FIG. 3, the speech recognition system 100 of the present disclosure may determine whether the first speech recognition result Sr1 conforms to a first speech recognition condition. For example, the speech recognition system 100 of the present disclosure may determine whether the first speech feature value Sr1 is larger than a first threshold. If the first speech feature value Sr1 is larger than the first threshold, the speech recognition system 100 of the present disclosure may generate a first pass signal Sp1. If the first speech feature value Sr1 is not larger than the first threshold, step 311 is executed again to continuously perform the speech recognition on the speech input Sin.

Referring to step 322 in FIG. 3, the speech recognition system 100 of the present disclosure may determine whether the second speech recognition result Sr2 conforms to a second speech recognition condition. For example, the speech recognition system 100 of the present disclosure may determine whether a second speech feature value Sr2 is larger than a second threshold. If the second speech feature value Sr2 is larger than the second threshold, the speech recognition system 100 of the present disclosure may generate a second pass signal Sp2. If the second speech feature value Sr2 is not larger than the second threshold, step 312 is executed again to continuously perform the speech recognition on the speech input Sin.

Referring to step 331 in FIG. 3, the speech recognition system 100 of the present disclosure may perform a computation according to the first pass signal Sp1 and the second pass signal Sp2 to generate an output signal Sout. In some embodiments, the step 331 may be performed by an AND gate, and therefore, the computation of step 331 may be an AND operation. However, the present disclosure is not limited thereto, and the present disclosure may also adopt other suitable computation methods, depending on actual requirements. Referring to FIG. 1 and FIG. 3, the speech recognition system 100 of the present disclosure may generate a speech recognition command according to the output signal Sout to perform subsequent speech control steps, such as dimming a screen, reducing an output volume, and other speech control steps.

In another embodiment of the present disclosure, referring again to step 311 and step 312 in FIG. 3, the speech recognition system 100 of the present disclosure may adopt the first algorithm and the second algorithm to perform the speech recognition on the speech input Sin to generate the first speech recognition result Sr1 and the second speech recognition result Sr2. For example, the speech recognition system 100 of the present disclosure may adopt the first algorithm and the second algorithm to perform the speech recognition on the speech input Sin to generate a speech feature value Sr1 and a text string Sr2.

Referring to step 321 in FIG. 3, the speech recognition system 100 of the present disclosure may determine whether the speech recognition result Sr1 conforms to the first speech recognition condition. For example, the speech recognition system 100 of the present disclosure may determine whether the speech feature value Sr1 is larger than a threshold. If the speech feature value Sr1 is larger than the threshold, the speech recognition system 100 of the present disclosure may generate the first pass signal Sp1. If the speech feature value Sr1 is not larger than the threshold, step 311 is executed again. Referring to step 322 in FIG. 3, the speech recognition system 100 of the present disclosure may determine whether the speech recognition result Sr2 conforms to the second speech recognition condition. For example, the speech recognition system 100 of the present disclosure may determine whether the text string Sr2 includes a wake word. If the text string Sr2 includes the wake word, the speech recognition system 100 of the present disclosure may generate the second pass signal Sp2. If the text string Sr2 does not include the wake word, step 312 is executed again. It should be noted that the operation of step 331 in this embodiment is the same as that in the previous embodiment, and to keep the description concise, it will not be described repeatedly herein. According to the above embodiment, the speech recognition system 100 and the speech recognition method 300 of the present disclosure may obtain the speech feature value Sr1 and the text string Sr2 through two algorithms. If the speech feature value Sr1 is larger than the threshold and the text string Sr2 includes the wake word, the speech recognition system 100 and the speech recognition method 300 of the present disclosure will generate the speech recognition command, thereby further improving the accuracy of the speech recognition. As a result, the present disclosure can further avoid a false awakening caused by a speech recognition error, thereby further preventing inconvenience caused by a false awakening of an electronic device.

In some embodiments, the speech recognition system 100 of the present disclosure may perform the speech recognition on the speech input by at least two electronic devices through at least two algorithms to generate at least two speech recognition results. For example, the present disclosure may adopt a television and a mobile phone to perform the speech recognition on the speech input of a user by two algorithms, thereby generating two corresponding speech recognition results. It should be noted that the two algorithms adopted in the present disclosure may be different algorithms. However, the present disclosure is not limited thereto, and the present disclosure may also adopt the same algorithm, depending on actual requirements. In addition, if the television and the mobile phone jointly perform the speech recognition to generate two speech recognition results, one of the at least two speech recognition conditions may be decreased. For example, referring to FIG. 3, assuming that the television performs step 311 and the mobile phone performs step 312, when the mobile phone performs step 312 to generate the speech recognition result Sr2, the speech recognition condition of the television in step 321 may be decreased at the same time (such as decreasing a threshold). As a result, if the threshold of the television is decreased, the success rate of the speech recognition performed by the television may be increased, so as to avoid excessively lowering the success rate of the speech recognition after the present disclosure adopts the two algorithms.

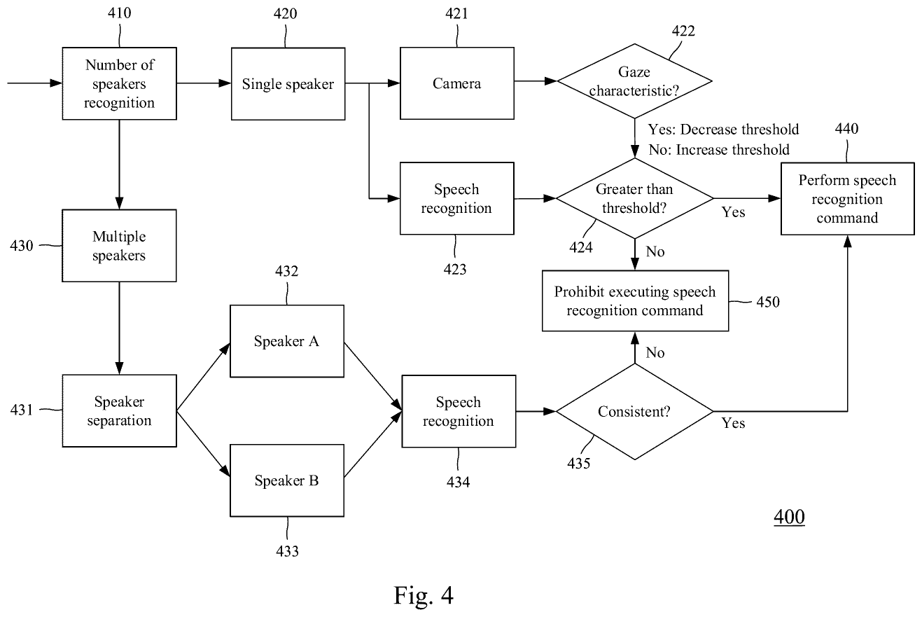

FIG. 4 shows an embodiment of a flow diagram of a speech recognition method 400 of the present disclosure. Referring to step 410 in FIG. 4, the speech recognition system 100 of the present disclosure may perform the speech recognition on the speech input to generate a number of speakers. As shown in step 420, if the number of speakers is one, referring to step 421, the present disclosure may perform the speech recognition on the speech input through one of the at least two algorithms by a camera to generate a speech recognition result. Referring to step 422, the present disclosure may identify whether a picture captured by the camera includes a gaze characteristic. If the picture captured by the camera includes the gaze characteristic, that is, the user is gazing at the camera, the present disclosure may decrease a speech recognition condition (such as decreasing a threshold). If the picture captured by the camera does not include the gaze characteristic, that is, the user is not gazing at the camera, the present disclosure may increase the speech recognition condition (such as increasing the threshold). As a result, if the speech recognition condition is decreased (such as decreasing the threshold), the success rate of the speech recognition may be increased, so as to avoid excessively lowering the success rate of the speech recognition after adopting the two algorithms. On the contrary, the speech recognition condition may also be adaptively increased (such as increasing the threshold), depending on actual requirements.

As shown in step 420, if the number of speakers is one, in another embodiment, referring to step 423, the present disclosure may perform the speech recognition on the speech input by an algorithm to generate a speech recognition result. Referring to step 424, the present disclosure may determine whether the speech recognition result is larger than a threshold, and as mentioned above, the threshold may be adjusted according to the result of step 422. If the speech recognition result is larger than the threshold, step 440 may be executed to perform the speech recognition command. If the speech recognition result is not larger than the threshold, step 450 may be executed to prohibit executing the speech recognition command.

Referring to step 410 in FIG. 4, the present disclosure may perform the speech recognition on the speech input to generate the number of speakers. As shown in step 430, if the number of speakers is multiple, referring to step 431, the present disclosure may perform speaker separation to obtain a speaker A in step 432 and a speaker B in step 433. Subsequently, referring to step 434, the present disclosure may perform the speech recognition on the speech inputs of the speaker A and the speaker B by an algorithm to generate a plurality of speech recognition commands. Referring to step 435, the present disclosure may determine whether the plurality of speech recognition commands of the speaker A and the speaker B are consistent. If the speech recognition commands are consistent, step 440 is executed to perform the speech recognition command. If the speech recognition commands are not consistent, step 450 is executed to prohibit executing the speech recognition command, that is, if the speech recognition commands of multiple users are not consistent, the speech recognition command is not executed so as to avoid a false triggering.

It should be noted that the present disclosure is not limited to the embodiments as shown in FIG. 1 to FIG. 4, they are merely examples for illustrating the implements of the present disclosure, and the scope of the present disclosure shall be defined based on the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

Technical features of some embodiments of the present disclosure make an improvement to the prior art. The speech recognition method and the speech recognition system of the present disclosure may perform the speech recognition on a speech input through at least two algorithms to further accurately recognize a corresponding speech recognition command. As a result, the present disclosure can avoid a false awakening caused by a speech recognition error, thereby preventing inconvenience caused by a false awakening of an electronic device. For example, the present disclosure can avoid affecting driving safety due to a navigation screen being dimmed while driving, and can also avoid affecting a meeting progress due to an electronic device outputting a greeting during a meeting.

It should be noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A speech recognition method, executed by a processor reading at least one command stored in a memory, comprising:
performing a speech recognition on a speech input by at least two algorithms to generate at least two speech recognition results;
if the at least two speech recognition results conform to at least two corresponding speech recognition conditions, generating at least two pass signals; and
generating at least one speech recognition command according to the at least two pass signals.

2. The speech recognition method of claim 1, wherein performing the speech recognition on the speech input by the at least two algorithms to generate the at least two speech recognition results comprises:
performing the speech recognition on the speech input by a first algorithm to generate a first speech recognition result; and
performing the speech recognition on the speech input by a second algorithm to generate a second speech recognition result.

3. The speech recognition method of claim 2, wherein if the at least two speech recognition results conform to the at least two corresponding speech recognition conditions, generating the at least two pass signals comprises:
if the first speech recognition result is larger than a first threshold, generating a first pass signal; and
if the second speech recognition result is larger than a second threshold, generating a second pass signal;
wherein generating the at least one speech recognition command according to the at least two pass signals comprises:
generating the at least one speech recognition command according to the first pass signal and the second pass signal.

4. The speech recognition method of claim 1, wherein performing the speech recognition on the speech input by the at least two algorithms to generate the at least two speech recognition results comprises:
performing the speech recognition on the speech input by a first algorithm to generate a speech recognition result; and
performing the speech recognition on the speech input by a second algorithm to generate a text string.

5. The speech recognition method of claim 4, wherein if the at least two speech recognition results conform to the at least two corresponding speech recognition conditions, generating the at least two pass signals comprises:
if the speech recognition result is larger than a threshold, generating a first pass signal; and
if the text string comprises a wake word, generating a second pass signal;
wherein generating the at least one speech recognition command according to the at least two pass signals comprises:
generating the at least one speech recognition command according to the first pass signal and the second pass signal.

6. The speech recognition method of claim 1, wherein performing the speech recognition on the speech input by the at least two algorithms to generate the at least two speech recognition results comprises:
performing the speech recognition on the speech input by the at least two algorithms through at least two electronic devices to generate the at least two speech recognition results.

7. The speech recognition method of claim 6, further comprising:
decreasing one of the at least two speech recognition conditions.

8. The speech recognition method of claim 1, wherein performing the speech recognition on the speech input by the at least two algorithms to generate the at least two speech recognition results comprises:
performing the speech recognition on the speech input by one of the at least two algorithms through a camera to generate one of the at least two speech recognition results;
wherein the speech recognition method further comprises:
if a picture taken by the camera comprises a gaze characteristic, adjusting one of the at least two speech recognition conditions.

9. The speech recognition method of claim 1, further comprising:
performing the speech recognition on the speech input to generate a number of speakers;
if the number of speakers is a plurality, determining whether a plurality of speech recognition commands generated by a plurality of corresponding speakers are consistent;
if the plurality of speech recognition commands are consistent, executing the plurality of speech recognition commands; and
if the plurality of speech recognition commands are inconsistent, prohibiting executing the plurality of speech recognition commands.

10. The speech recognition method of claim 1, further comprising:
if the at least one speech recognition command comprises a stop word, stopping executing the speech recognition method.

11. A speech recognition system, comprising:
a memory, configured to store at least one command;
a processor, configured to read the at least one command in the memory to execute:
performing a speech recognition on a speech input by at least two algorithms to generate at least two speech recognition results;
if the at least two speech recognition results conform to at least two corresponding speech recognition conditions, generating at least two pass signals; and
generating at least one speech recognition command according to the at least two pass signals.

12. The speech recognition system of claim 11, wherein the processor further reads the at least one command in the memory to execute:
performing the speech recognition on the speech input by a first algorithm to generate a first speech recognition result; and
performing the speech recognition on the speech input by a second algorithm to generate a second speech recognition result.

13. The speech recognition system of claim 12, wherein the processor further reads the at least one command in the memory to execute:
if the first speech recognition result is larger than a first threshold, generating a first pass signal;
if the second speech recognition result is larger than a second threshold, generating a second pass signal; and
generating the at least one speech recognition command according to the first pass signal and the second pass signal.

14. The speech recognition system of claim 11, wherein the processor further reads the at least one command in the memory to execute:
performing the speech recognition on the speech input by a first algorithm to generate a speech recognition result; and
performing the speech recognition on the speech input by a second algorithm to generate a text string.

15. The speech recognition system of claim 14, wherein the processor further reads the at least one command in the memory to execute:
if the speech recognition result is larger than a threshold, generating a first pass signal;
if the text string comprises a wake word, generating a second pass signal; and
generating the at least one speech recognition command according to the first pass signal and the second pass signal.

16. The speech recognition system of claim 11, wherein the processor further reads the at least one command in the memory to execute:
performing the speech recognition on the speech input by the at least two algorithms through at least two electronic devices to generate the at least two speech recognition results.

17. The speech recognition system of claim 16, wherein the processor further reads the at least one command in the memory to execute:
decreasing one of the at least two speech recognition conditions.

18. The speech recognition system of claim 11, wherein the processor further reads the at least one command in the memory to execute:
performing the speech recognition on the speech input by one of the at least two algorithms through a camera to generate one of the at least two speech recognition results; and
if a picture taken by the camera comprises a gaze characteristic, adjusting one of the at least two speech recognition conditions.

19. The speech recognition system of claim 11, wherein the processor further reads the at least one command in the memory to execute:
performing the speech recognition on the speech input to generate a number of speakers;
if the number of speakers is a plurality, determining whether a plurality of speech recognition commands generated by a plurality of corresponding speakers are consistent;
if the plurality of speech recognition commands are consistent, executing the plurality of speech recognition commands; and
if the plurality of speech recognition commands are inconsistent, prohibiting executing the plurality of speech recognition commands.

20. The speech recognition system of claim 11, wherein the processor further reads the at least one command in the memory to execute:
if the at least one speech recognition command comprises a stop word, stopping executing the speech recognition system.
